(19) United States
(12) Patent Application Publication
(10) Pub. No.: US 2018/0367841 A1
(43) Pub. Date: Dec. 20, 2018

(54) INFORMATION PROCESSING APPARATUS AND NON-TRANSITORY COMPUTER READABLE MEDIUM

(71) Applicant: FUJI XEROX CO., LTD., Tokyo (JP)

(72) Inventor: Toshiaki KOUE, Kanagawa (JP)

(73) Assignee: FUJI XEROX CO., LTD., Tokyo (JP)

(21) Appl. No.: 15/995,211

(22) Filed: Jun. 1, 2018

(30) Foreign Application Priority Data
Jun. 16, 2017 (JP) 2017-118909

(51) Int. Cl. H04N 21/438; H04N 21/462; H04H 20/10

(52) U.S. Cl. CPC H04N 21/4384; H04H 20/10; H04N 21/462

(57) ABSTRACT

An information processing apparatus includes a communication unit and a change unit. The communication unit is configured to conduct a wireless communication using plural transmission methods each having plural channels. When a channel or a transmission method is switched during a communication, the change unit changes contents to be communicated after the switching, according to the channel after the switching or the transmission method after the switching.

### CROSS-REFERENCE TO RELATED APPLICATIONS

This application is based on and claims priority under 35 USC 119 from Japanese Patent Application No. 2017-118909 filed Jun. 16, 2017.

### BACKGROUND

### Technical Field

The present invention relates to an information processing apparatus and a non-transitory computer readable medium.

### SUMMARY

According to an aspect of the invention, an information processing apparatus includes a communication unit and a change unit. The communication unit is configured to conduct a wireless communication using plural transmission methods each having plural channels. When a channel or a transmission method is switched during a communication, the change unit changes contents to be communicated after the switching, according to the channel after the switching or the transmission method after the switching.

### BRIEF DESCRIPTION OF THE DRAWINGS

Exemplary embodiments of the present invention will be described in detail based on the following figures, wherein:

FIG. 1 is a view illustrating a conceptual module configuration relating to an exemplary configuration of an exemplary embodiment;

FIGS. 2A and 2B are explanatory views illustrating exemplary system configurations using the exemplary embodiment;

FIG. 3 is an explanatory view illustrating a specific exemplary configuration of the exemplary embodiment;

FIGS. 4A and 4B are explanatory views illustrating examples of channels;

FIG. 5 is a flowchart illustrating an exemplary process by the exemplary embodiment;

FIG. 6 is a flowchart illustrating an exemplary process by the exemplary embodiment;

FIG. 7 is a flowchart illustrating an exemplary process by the exemplary embodiment;

FIG. 8 is a flowchart illustrating an exemplary process by the exemplary embodiment;

FIG. 9 is an explanatory view illustrating an exemplary data structure of a priority table;

FIG. 10 is an explanatory view illustrating an exemplary data structure of a priority table;

FIG. 11 is a flowchart illustrating an exemplary process by the exemplary embodiment;

FIG. 12 is a flowchart illustrating an exemplary process according to the exemplary embodiment;

FIG. 13 is a flowchart illustrating an exemplary process according to the exemplary embodiment;

FIG. 14 is a flowchart illustrating an exemplary process according to the exemplary embodiment; and

FIG. 15 is a block diagram illustrating an exemplary hardware configuration of a computer implementing the exemplary embodiment.

### DETAILED DESCRIPTION

Hereinafter, an exemplary embodiment suitable for implementing the present invention will be described with reference to the accompanying drawings.

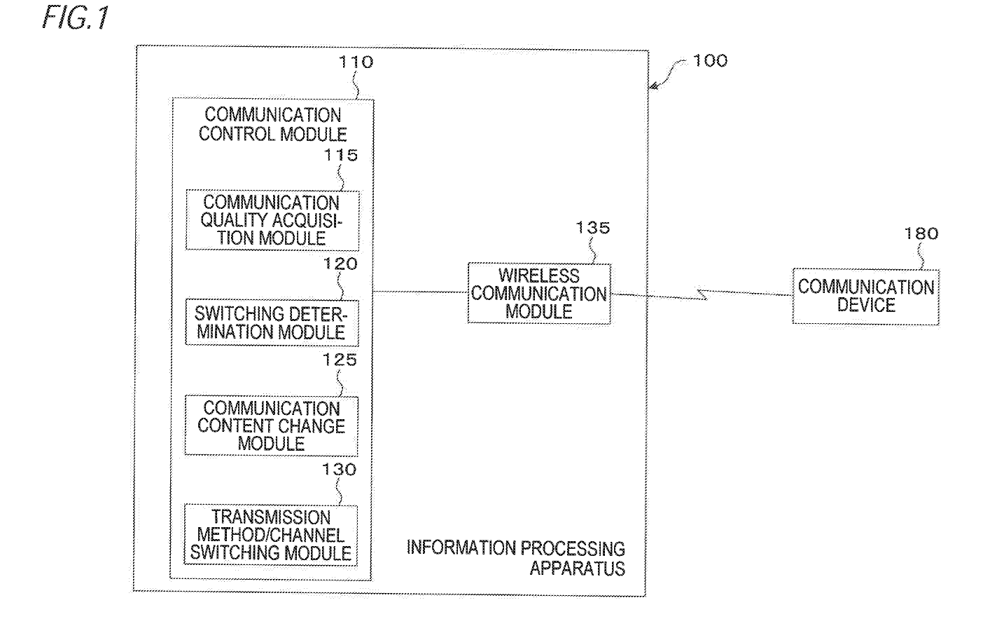

FIG. 1 is a view illustrating a conceptual module configuration relating to an exemplary configuration of the present exemplary embodiment.

A module, in general, indicates a logically separable component such as software (computer program) or hardware. Accordingly, a module in the present exemplary embodiment indicates not only a module in a computer program but also a module in a hardware configuration. Thus, the descriptions of the present exemplary embodiment also include descriptions of a computer program to serve as a module (a program that causes a computer to execute respective processes, a program that causes a computer to serve as respective units, and a program that causes a computer to implement respective functions), a system, and a method. For convenience of descriptions, the expressions “store,” “caused to store,” and equivalent expressions thereto will be used. If an exemplary embodiment is directed to a computer program, the expressions indicate storing data or the like in a memory device or performing a control to cause data or the like to be stored in a memory device. In addition, one module may correspond to one function. In implementation, however, one module may be configured with one program, multiple modules may be configured with one program, and in reverse, one module may be configured with multiple programs. Further, multiple modules may be executed by one computer, or one module may be executed by multiple computers in a distributed or parallel environment. In addition, one module may include another module. Hereinafter, the term “connection” is also used for a logical connection (for example, data exchange, instructions, and a reference relationship among data), in addition to a physical connection. The term “predetermined” refers to being determined prior to a target process. The term “predetermined” includes the meaning of being determined according to a circumstance/state at or until a specific time point not only before a process by the present exemplary embodiment is started, but also prior to a target process even after a process by the present exemplary embodiment is started. If multiple “predetermined values” exist, the predetermined values may be different from each other, or two or more of the predetermined values (or all the predetermined values, of course) may be equal to each other. In addition, the description “when it is A, B is performed” indicates that “it is determined whether it is A, and if it is determined that it is A, B is performed,” except for a case where it is unnecessary to make the determination as to whether it is A. If items are enumerated like “A, B, and C,” the enumeration is merely exemplary and includes a case of selecting only one (for example, only A) of the items, unless otherwise specified.

In addition, a system or device includes a system or device which is implemented with one computer, hardware component, device or the like, in addition to a system or device configured such that multiple computers, hardware components, devices and the like are connected to each other by a communication unit such as a network (including a one-to-one corresponding communication connection). The terms “device” and “system” are synonymous with each other. Of course, the “system” does not include a system merely meaning a social “structure” (social system) which is an artificial engagement.

In addition, target information is read from a memory device per process by each module or for each of multiple processes which are executed in a module. After the process is executed, the process result is stored in the memory device. Accordingly, descriptions of reading from the memory device prior to the process and storing in the memory device after the process may be omitted. Examples of the memory device may include a hard disk, a random access memory (RAM), an external memory medium, a memory device through a communication line, a register within a central processing unit (CPU), and the like.

An information processing apparatus 100 according to the present exemplary embodiment conducts a wireless communication, and includes a communication control module 110 and a wireless communication module 135 as illustrated in the example of FIG. 1.

A communication device 180 is connected to the wireless communication module 135 of the information processing apparatus 100 via a communication line. The communication device 180 is capable of conducting a wireless communication and is, for example, a mobile information terminal, a notebook PC, or an access point. There may be provided multiple communication devices 180 that are capable of conducting a wireless communication with the information processing apparatus 100. For example, there may be a case where multiple communication devices 180 each equipped with WiGig are provided and more communication devices 180 than the number of communication lines, in the information processing apparatus 100, capable of conducting the WiGig communication may request a communication. This case corresponds to, for example, a case where a communication device 180 serving as an authentication device, another communication device 180 serving as a storage device, further another communication device 180 serving as a display device, and the like request a communication. In this case, one of the communication devices 180 conducts a communication by WiGig and other ones of the communication devices 180 conduct a communication by transmission methods other than WiGig (transmission methods having a slower communication speed than WiGig). However, in general, communication times of the communication devices 180 are different from each other. Thus, when the communication of the communication device 180 which is conducting a communication using WiGig is ended, the information processing apparatus 100 switches a transmission method of another communication device 180 to WiGig even if the other communication device 180 has already conducted a communication using a transmission method other than WiGig. As a result, the communication may be completed faster than the case where the communication by the transmission method other than WiGig is continued.

The wireless communication module 135 is connected to the communication control module 110 and also connected to the communication device 180 via a communication line. The wireless communication module 135 is capable of conducting a wireless communication using multiple transmission methods. Further, the wireless communication module 135 is capable of conducting a wireless communication with multiple communication devices 180. The multiple transmission methods may include, for example, IEEE802.11a, IEEE802.11b, IEEE802.11c, IEEE802.11g, IEEE802.11n, IEEE802.11ac, IEEE802.11j, IEEE802.11ad, and Bluetooth (registered trademark).

In addition, at least one of the transmission methods of the wireless communication module 135 has multiple channels (wireless communication paths). Of course, each of all the transmission methods may have multiple channels.

The transmission methods by which the wireless communication module 135 is capable of conducting a wireless communication may include at least the communication standard of IEEE802.11ad.

The communication control module 110 includes a communication quality acquisition module 115, a switching determination module 120, a communication content change module 125, and a transmission method/channel switching module 130. The communication control module 110 is connected to the wireless communication module 135. The communication control module 110 controls the wireless communication between the information processing apparatus 100 and the communication device 180.

The communication quality acquisition module 115 acquires the quality of a communication that is being conducted using the wireless communication module 135. Here, the “quality of a communication” (communication quality) includes a transmission quality, a connection quality, and a stability quality. Examples of the communication quality include a communication speed (for example, a communication speed, a delay, and a responsiveness), a stability (for example, a data loss rate and a reliability), and a coverage range. Specifically, acquisition of the communication quality corresponds to detecting a wireless communication speed, a reception level of a radio signal, an occurrence of disconnection of a wireless communication during the communication, or the like.

The switching determination module 120 determines whether a channel or transmission method having a higher communication quality than the communication quality of the communication that is being conducted has become able to communicate.

Here, the description “channel or transmission method having a higher communication quality than the communication quality of the communication that is being conducted” indicates, for example, a channel or transmission method which is more superior in the communication speed, the number of errors or the like than the channel or transmission method of the communication that is being currently conducted.

In addition, a “case where a channel B1 or a transmission method B2 has become able to communicate” represents a case where since a communication using the channel B1 or the transmission method B2 could not be selected at the time of starting a communication, the communication was conducted using another channel A1 or another transmission method A2, and during the communication, the channel B1 or the transmission method B2 has become able to communicate. Here, examples of the description “a communication using the channel B1 or the transmission method B2 could not be selected” include (i) a case where a communication by the channel B1 or the transmission method B2 has already been conducted and (ii) a case where a communication by the channel B1 or the transmission method B2 could not be conducted due to an error or the like.

In addition, the switching determination module 120 may determine whether to perform the switching, according to the remaining communication amount. Here, the description “according to a remaining communication amount” may indicate that a time required for the remaining communication when the communication by the current channel A1 or transmission method A2 is continued and a time required when a communication is started from the beginning by the channel B1 or the transmission method B2 that has become in a switchable state are compared to each other and it is determined that one of the former and the latter is shorter than the other.

If a channel or a transmission method is switched during a communication, the communication content change module 125 changes the contents to be communicated after the switching, according to the channel after the switching or the transmission method after the switching.

In addition, the communication content change module 125 may change the contents to be communicated after the switching, according to the contents to be communicated.

For example, if the contents to be communicated are not divisible, the communication content change module 125 may communicate the contents from the beginning after the switching. Here, the condition “if the contents to be communicated are not divisible” is met, for example, in a case where the contents to be communicated are moving image information, audio information, or the like. This is because time-series information is necessary. Especially, the condition “if the contents to be communicated are not divisible” is met in a case where the communication contents may not be changed (for example, change of a resolution of an image as described later may not be made) during a communication (at an intermediate portion of data). Even if the contents to be communicated are moving image information, when the moving image information is divided into chapters, the moving image information may be treated as meeting “if the contents to be communicated are divisible.”

In addition, if the contents to be communicated are divisible, the communication content change module 125 may continue the communication of the remaining contents after the switching. The condition “if the contents to be communicated are divisible” is met, for example, in a case where the contents to be communicated are an image, a document, or the like. Specifically, when multiple sheets of images are transmitted, each image may be divided into the respective sheets. When a document having multiple pages is transmitted, the document may be divided into the respective pages. It should be noted that of course, a communication may well be continued until the first half of the divided contents is transmitted, and the switching may be performed after the first half of the divided contents is transmitted.

In addition, if the channel after the switching or the transmission method after the switching has a higher communication quality than the channel before the switching or the transmission method before the switching, the communication content change module 125 may change the contents to be communicated so that a capacity of the contents to be communicated after the switching is larger than that of the contents before the switching. In addition, if a communication completion time A in a case where communication is continued by the transmission method before the switching or the channel before the switching is compared with a communication completion time B in a case where a communication is started by the transmission method after the switching or the channel after the switching and the communication completion time B is faster, the change to increase the capacity may be made.

For example, if the contents to be communicated are an image, the communication content change module 125 may change the resolution of the image to be communicated after the switching to be higher than that of the image before the switching. For example, assuming that the resolution of an image is initially set to 200 dpi (dots per inch). In this case, if a transmission method or channel is switched to a transmission method or channel having a higher communication speed (for example, switching from IEEE802.11n to IEEE802.11ad), the resolution of the image may be changed to 600 dpi. As a result, the communication device 180 may obtain a clearer image (higher quality image).

If a channel or transmission method having a higher communication quality than the communication quality of the communication that is being conducted has become able to communicate, the transmission method/channel switching module 130 switches the communication that is being conducted to the channel or transmission method. That is, the communication is switched to a channel or transmission method having a higher communication quality, according to the result of the determination by the switching determination module 120 (the result of the determination as to whether a channel or transmission method having a higher communication quality than the communication quality of the communication that is being conducted has become able to communicate).

In addition, the transmission method/channel switching module 130 performs the switching according to the remaining communication amount. That is, switching between channels or transmission methods is performed, according to the result of the determination by the switching determination module 120 (the result of the determination as to whether to switch between communications according to the remaining communication amount).

In addition, when switching between transmission methods, the transmission method/channel switching module 130 may switch the transmission method to IEEE802.11ad.

In addition, the transmission method/channel switching module 130 may succeed to and use the information about the communication before the switching when the communication is disconnected and reconnected. Here, the “information about the communication before the switching” corresponds to, for example, information about communication contents such as the communication capability of the communication device 180 which is a communication counterpart device and the like. In addition, when communication contents is an image, the “information about communication contents” corresponds to, for example, the resolution, the number of pages (for example, the number of entire pages, the number of completely transmitted pages, and the like), a file type, a coding method, and the like.

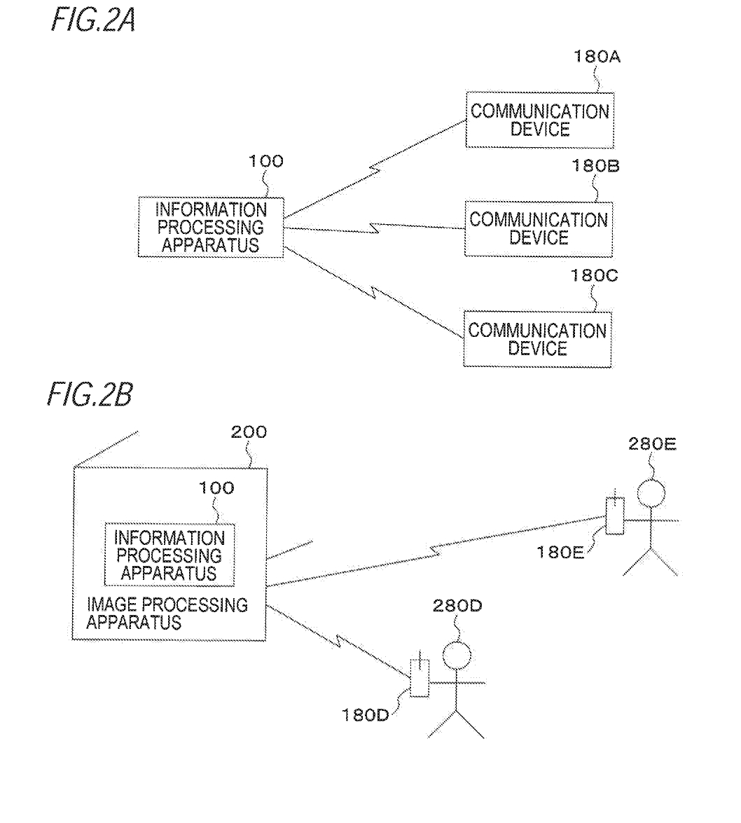

FIGS. 2A and 2B are explanatory views illustrating an exemplary system configuration using the present exemplary embodiment.

As illustrated in the example of FIG. 2A, the information processing apparatus 100 conducts a wireless communication with multiple communication devices 180 (communication devices 180A, 180B, and 180C). The wireless communication is conducted by a transmission method enabling the mutual communication between the information processing apparatus 100 and the communication devices 180. A channel is determined according to a predetermined algorithm at the time of starting the communication.

In the wireless communication, the communication quality may change during the communication. For example, the communication quality may change due to a usage environment, a congestion status, a malfunction, and the like. More specifically, the communication quality may change due to movement of an obstacle for a wireless communication (for example, an automobile, opening/closing of a door, and persons), movement of the information processing apparatus 100 or the communication devices 180 (for example, movement of the owner of the information processing apparatus 100 or the communication devices 180 when the information processing apparatus 100 or the communication devices 180 are mobile devices), use of another device (for example, a microwave oven and other communication devices), and traffics.

If a communication having a better communication quality than that of a communication that is being conducted becomes possible, the information processing apparatus 100 of this exemplary embodiment may switch the current communication to a transmission method or channel of the possible communication.

As illustrated in the example of FIG. 2B, an image processing apparatus 200 may have the information processing apparatus 100.

The image processing apparatus 200 is capable of conducting a wireless communication with a communication device 180D of a user 280D and a communication device 180E of a user 280E.

For example, the user 280D transmits a printing instruction to the image processing apparatus 200 by operating the communication device 180D and gets a printed matter from the image processing apparatus 200. In addition, the user 280E transmits a scanned image to the communication device 180E to store the image in the communication device 180E, by performing a scan operation with the image processing apparatus 200. In these cases (printing instruction and image reading), as described above, when the communication is switched to a transmission method or channel having a higher communication speed, the image to be transmitted may be changed to an image having a higher image quality even during the communication.

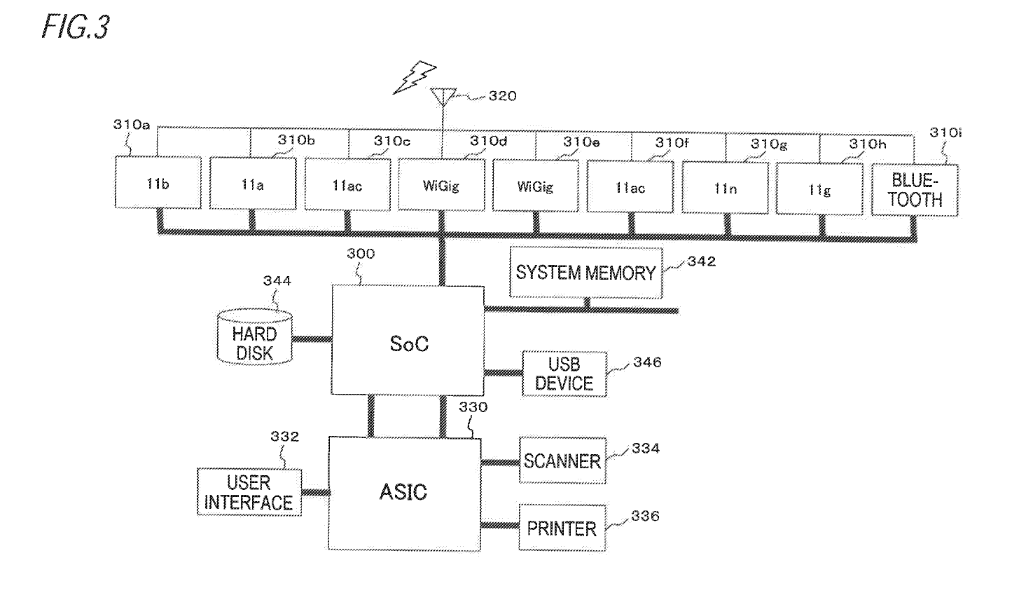

FIG. 3 is an explanatory view illustrating a specific exemplary configuration of the present exemplary embodiment (the image processing apparatus 200). The image processing apparatus 200 includes a System On a Chip (SoC) 300, 11b:310a, 11a:310b, 11ac:310c, WiGig:310d, WiGig:310e, 11ac:310f, 11n:310g, 11g:310h, Bluetooth 310i, an antenna 320, a system memory 342, a hard disk 344, a USB device 346, an application specific integrated circuit (ASIC) 330, a user interface 332, a scanner 334, and a printer 336.

11b:310a is connected to the antenna 320 and the SoC 300. 11a:310b is connected to the antenna 320 and the SoC 300. 11ac:310c is connected to the antenna 320 and the SoC 300. WiGig:310d is connected to the antenna 320 and the SoC 300. WiGig:310e is connected to the antenna 320 and the SoC 300. 11ac:310f is connected to the antenna 320 and the SoC 300. 11n:310g is connected to the antenna 320 and the SoC 300. 11g:310h is connected to the antenna 320 and the SoC 300. Bluetooth 310i is connected to the antenna 320 and the SoC 300. The antenna 320 maybe shared. Further, multiple antennas 320 maybe provided. The combination of the communication devices (communication chips) 310 and the antenna 320 is an example implementing the wireless communication modules 135 illustrated in the example of FIG. 1. 11b:310a to 11g:310h comply with the “IEEE 802.11 standard” which is the international standard of the wireless communication standard and includes “a,” “a/b,” “b/g,” “a/b/g/n,” and the like. Of course, Wireless Fidelity (Wi-Fi) which is a product complying with the above-described standard may be used. Especially, IEEE802.11ad which is a wireless communication standard of the 60 GHz band may be adopted. That is, WiGig (Wireless Gigabit) which is a product complying with IEEE802.11ad may be used. As the transmission method of the wireless communication, transmission methods such as Bluetooth 310i other than the “IEEE802.11 standard” may be used.

The SoC 300 is connected to 11b:310a, 11a:310b, 11ac:310c, WiGig:310d, WiGig:310e, 11ac:310f, 11n:310g, 11g:310h, Bluetooth 310i, the system memory 342, the hard disk 344, the USB device 346, and the ASIC 330. The SoC 300 is an example implementing the communication control module 110. The SoC 300 mainly controls the communication devices (communication chips) 310, the system memory 342, the hard disk 344, and the USB device 346.

The system memory 342 is connected to the SoC 300. The system memory 342 is, for example, a memory used for executing programs of the communication control module 110.

The hard disk 344 is connected to the SoC 300. The hard disk 344 stores, for example, priority tables 900 and 1000, communication contents and the like.

The USB device 346 is connected to the SoC 300. The USB device 346 reads from and writes into, for example, an external connection device such as a removable storage medium and an IC card. In addition, another communication device may be connected.

The ASIC 330 is connected to the SoC 300, the user interface 332, the scanner 334, and the printer 336. The ASIC 330 controls the scanner 334, the printer 336, the user interface 332 and the like to implement the main functions of the image processing apparatus 200.

The user interface 332 is connected to the ASIC 330. The user interface 332 receives an operation by a user and presents a message or the like to the user by controlling, for example, a liquid crystal display also serving as a touch panel. In addition, the user interface 332 may receive the user's operation (including gaze, gesture, voice, and the like) using a mouse, a keyboard, a camera, a microphone or the like, and may present a message to the user by voice output from a loudspeaker or touch sense using a touching device.

The scanner 334 is connected to the ASIC 330. The scanner 334 reads an image of an original document and transmits the image.

The printer 336 is connected to the ASIC 330. The printer 336 performs printing according to a printing instruction received by the communication devices (communication chips) 310 or the user interface 332.

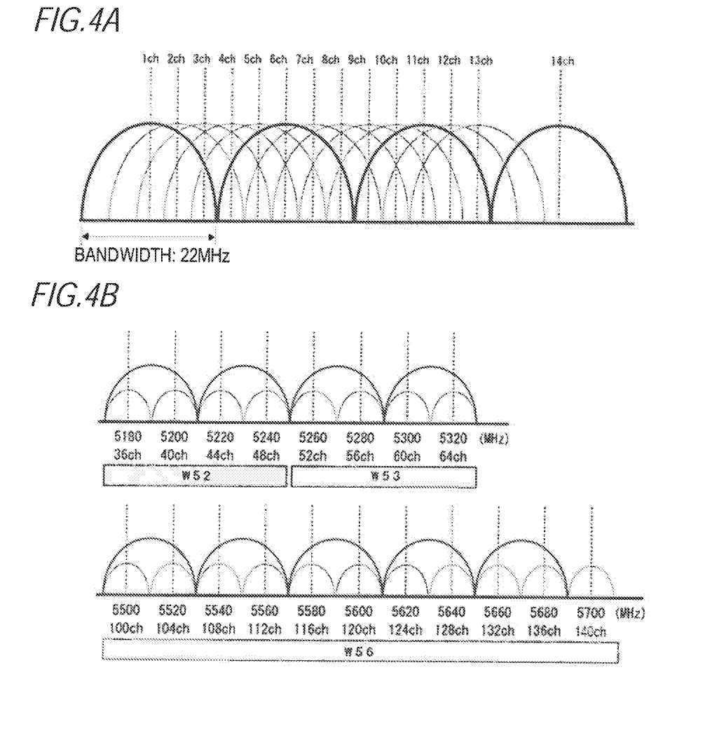

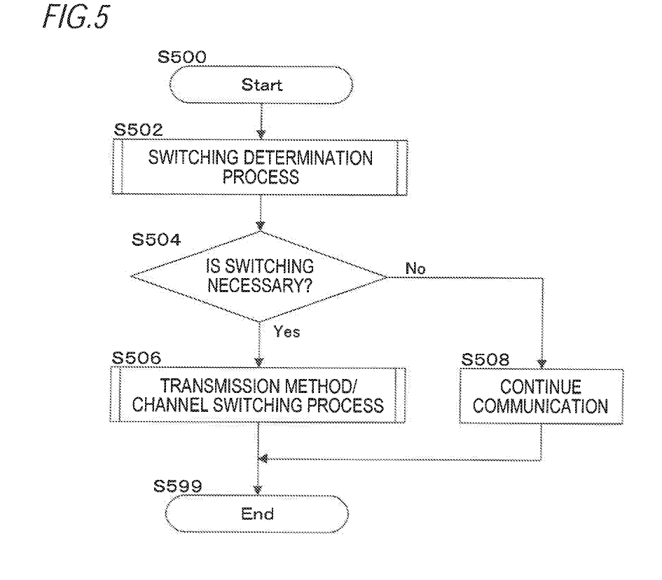

FIGS. 4A and 4B are explanatory diagrams illustrating examples of channels.

For example, descriptions will be made on channels in the “2.4 GHz band” and the “5 GHz band” of the “IEEE 802.11 standard.”

The wireless standard using the “2.4 GHz band” is easily affected by other devices and is difficult to conduct a stable communication. For example, if a microwave oven or another identical wireless LAN device exists nearby, the communication often becomes unstable. Meanwhile, compared to the “5 GHz band,” radio waves reach far away and are less affected by an obstacle or the like. Further, the “2.4 GHz band” is used by many devices and highly compatible.

Since the “5 GHz band” is used by a small number of devices, the “5 GHz band” is less affected by a microwave oven and the like and may be expected to conduct a stable communication. Meanwhile, when a blocking object exists, the “5 GHz band” is easily affected by the blocking object, as compared to the “2.4 GHz band,” and may not conduct a stable communication as the walls increase.

In the above-described IEEE802.11ad of the 60 GHz band, while the possible communication distance is as short as about 10 m, a large capacity and high-speed communication may be conducted. Although IEEE802.11ad of the 60 GHz may not pass over a blocking object due to the strong straight traveling property, the transmission and reception characteristic may be improved by adopting the directivity control by multiple antennas. As described above, since merits and demerits exist depending on the transmission methods, it is effective to switch to another transmission method even during a communication.

In addition, it may be effective to switch to another channel even during a communication.

The range of frequencies that may be used in a wireless communication is fixed. A frequency band to be used is divided into “channels” within the range such that multiple communication devices may conduct communications simultaneously using different channels.

In IEEE802.11b/g/n using the 2.4 GHz band, the frequency band is divided into 13 channels of 1 ch to 13 ch each having the channel width of 20 MHz in Japan and Europe. The frequency band is divided into 11 channels of 1 ch to 11 ch each having the channel width of 20 MHz in the United States.

In IEEE802.11a/n/ac using the 5 GHz band, the frequency band is divided into 19 channels of 36 ch to 64 ch and 100 ch to 140 ch each having the channel width of 20/40 MHz and 80/160 MHz.

In IEEE802.11ad using the 60 GHz band, the frequency band is divided into four channels of 1 ch to 4 ch each having the channel width of 9 GHz.

As illustrated in the example of FIG. 4A, in IEEE802.11b/g/n using the 2.4 GHz band in Japan, for example, 1 ch has the center frequency of 2,412 MHz and the band of 2,401 MHz to 2,423 MHz, 2 ch has the center frequency of 2,417 MHz and the band of 2,406 MHz to 2,428 MHz, 3 ch has the center frequency of 2,422 MHz and the band of 2,411 MHz to 2,433 MHz, 4 ch has the center frequency of 2,417 MHz and the band of 2,416 MHz to 2,438 MHz, 5 ch has the center frequency of 2,432 MHz and the band of 2,421 MHz to 2,443 MHz, 6 ch has the center frequency of 2,437 MHz and the band of 2,426 MHz to 2,448 MHz, 7 ch has the center frequency of 2,442 MHz and the band of 2,431 MHz to 2,453 MHz, 8 ch has the center frequency of 2,447 MHz and the band of 2,436 MHz to 2,458 MHz, 9 ch has the center frequency of 2,452 MHz and the band of 2,441 MHz to 2,463 MHz, 10 ch has the center frequency of 2,457 MHz and the band of 2,446 MHz to 2,468 MHz, 11 ch has the center frequency of 2,462 MHz and the band of 2,451 MHz to 2,473 MHz, 12 ch has the center frequency of 2,467 MHz and the band of 2,456 MHz to 2,478 MHz, 13 ch has the center frequency of 2,472 MHz and the band of 2,461 MHz to 2,483 MHz, 14 ch has the center frequency of 2,484 MHz and the band of 2,473 MHz to 2,495 MHz.

As described above, the frequency band of a channel overlaps with the frequency band of an adjacent channel. This is called an “overlap.” Specifically, in a case of the “channel width of 20 MHz,” three channels overlap with each other in the front and rear portions. In a case of the “channel width of 22 MHz,” four channels overlap with each other in the front and rear portions. These channels are in the mutually interfering relationship.

That is, when one unit uses “1 ch” and another unit uses “2 ch” in a wireless communication, the channels interfere with each other. As a result, the communication may become unstable.

In a case where three (or four) channels overlap with each other, shifting the channels by the number of overlapping channels +1 avoids interference between the channels. If “1 ch, 5 ch, 9 ch, and 13 ch” are used in the case of the “channel width of 20 MHz,” and “1 ch, 6 ch, 11 ch (2 ch, 7 ch, and 12 ch or 3 ch, 8 ch, and 13 ch)” are used in the case of the “channel width of 22 MHz,” the communication becomes stable. Thus, the channels that may be expected to conduct a stable communication (non-overlapping channels) are the four (or three) channels.

As illustrated in the example of FIG. 4B, in IEEE802.11a/n/ac using the 5 GHz band, 19 channels are present in Japan and Europe. Not illustrated in FIG. 4B, in IEEE802.11a/n/ac using the 5 GHz band, 24 channels are present in the United States. The frequency bands of the respective channels are independent and do not interfere with each other. That is, the interference does not occur even if an adjacent channel is allocated. Thus, if the 5 GHz band is used, not only the interference with other devices disappears but also the interference with the channels disappears.

In addition, as the switching between the channels, a “channel bonding” function (a high speed mode) maybe included. That is, as the switching between the channels, added are switching of a wireless communication which does not use the channel bonding function to a wireless communication which uses the channel bonding function, switching of a wireless communication which uses the channel bonding function to a wireless communication which does not use the channel bonding function and switching between wireless communications that use the channel bonding function. The channel bonding function is a technique of using two channels simultaneously and bonding the channels to each other so as to increase the communication speed. For example, the band occupied by one channel is 20 MHz. If the bands of two channels are bonded to each other, a communication is conducted in the 40 MHz band. It should be noted that if the channel bonding function is used, the number of available channels decreases, and the interference may easily occur. Further, a master device and an associated device are required to conform to the channel bonding function.

In addition, as the switching of a transmission method, “multiple input, multiple output (MIMO)” may be included. That is, as the switching between the transmission methods, added are changing of a wireless communication which does not use the MIMO to a wireless communication which uses the MIMO, changing of a wireless communication which uses the MIMO to a wireless communication which does not use the MIMO, and changing between antennas according to the MIMO The MIMO is a technique in which both a transmitter and a receiver use multiple antennas in a wireless communication so as to implement a high speed communication. In addition, a master device and an associated device are required to conform to the MIMO.

FIG. 5 is a flowchart illustrating an exemplary process by the present exemplary embodiment.

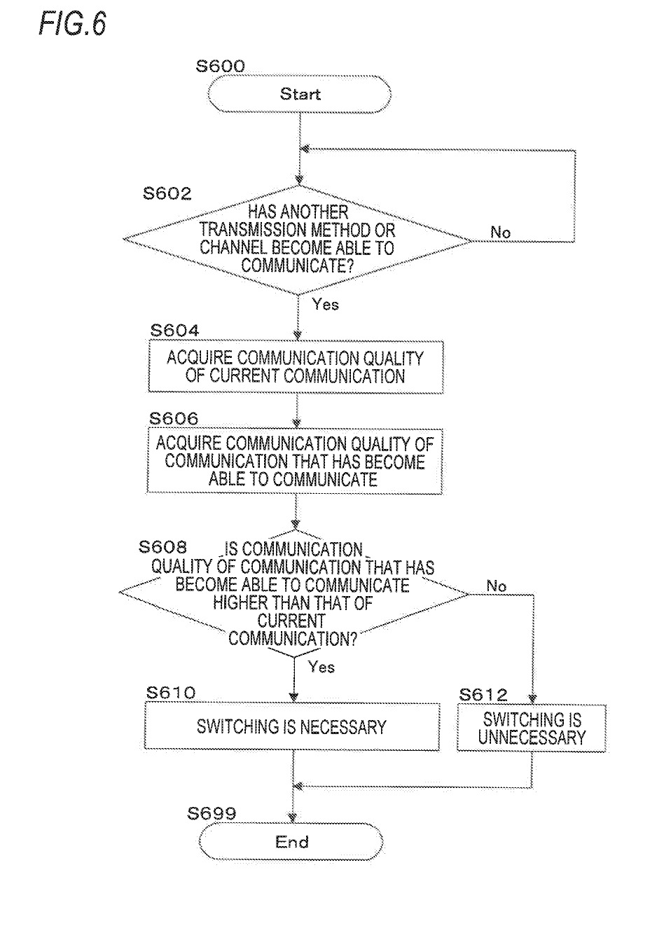

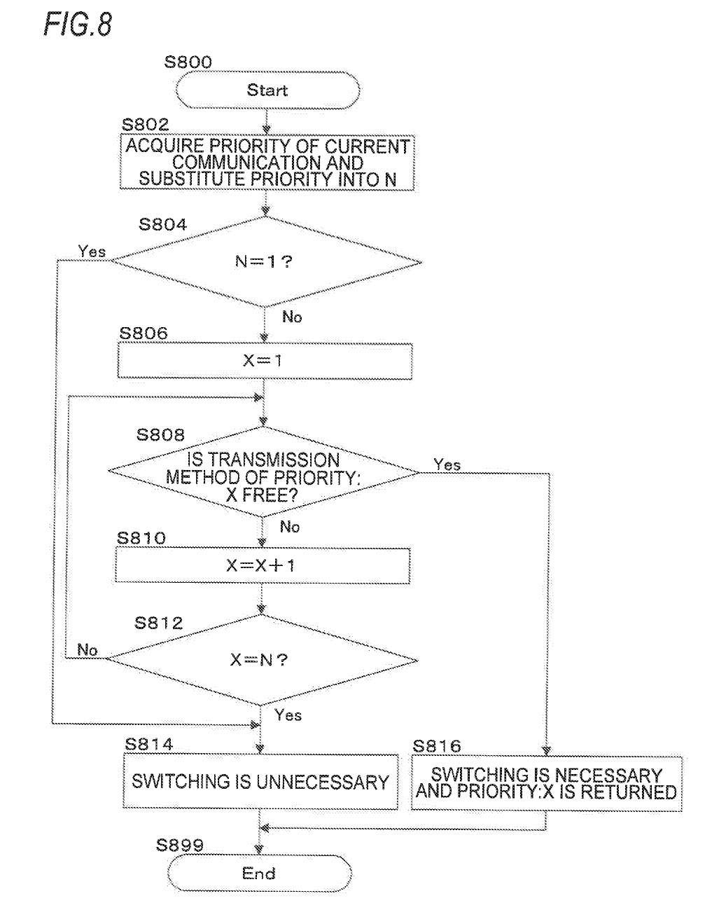

In step S502, the switching determination module 120 performs a switching determination process. A detailed process of step S502 will be described later using a flowchart illustrated in an example of FIG. 6 or 8.

In step S504, it is determined whether a switching is necessary, as a result of the process in step S502. If it is determined that a switching is necessary, the process proceeds to step S506. Otherwise, the process proceeds to step S508.

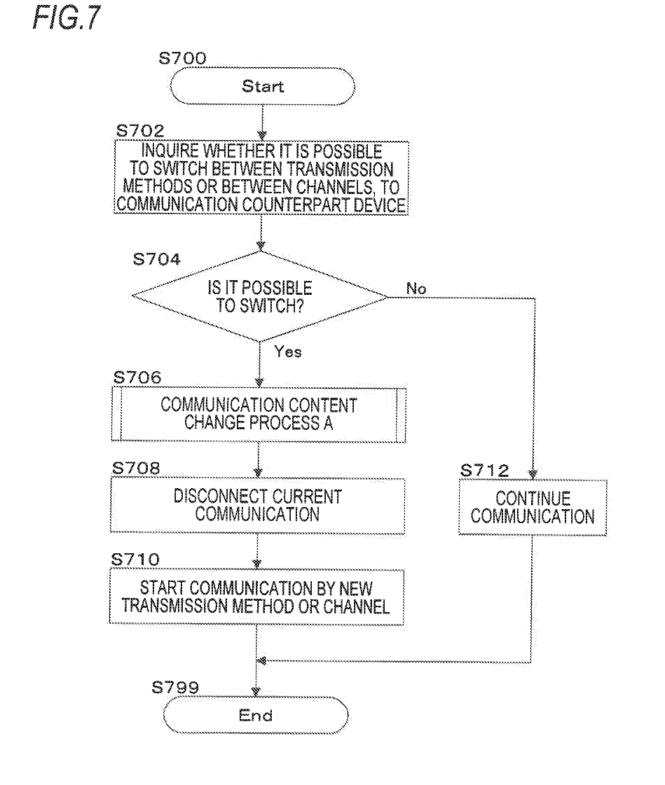

In step S506, the transmission method/channel switching module 130 performs a transmission method/channel switching process. A detailed process of step S506 will be described later using the flowchart illustrated in an example of FIG. 7.

In step S508, the wireless communication module 135 continues the communication by the current transmission method and channel.

FIG. 6 is a flowchart illustrating an exemplary process according to the present exemplary embodiment (switching determination module 120).

In step S602, it is determined whether another transmission method or channel has become able to communicate. If it is determined that another transmission method or channel has become able to communicate, the process proceeds to step S604. Otherwise, the process stands by until another transmission method or channel becomes able to communicate. In step S708 of a flowchart illustrated in an example of FIG. 7 a communication is started by the “other transmission method or channel” which is determined in step S602 to have become able to communicate.

In step S604, the communication quality of the current communication is acquired.

In step S606, the communication quality of the communication that has become able to communicate (the communication by the “other transmission method or channel”) is acquired. As described above, if the communication by the “other transmission method or channel” has been conducted until that time, the communication quality in the communication performance may be acquired. If a communication itself could not be conducted, a nominal value in the communication by the “other transmission method or channel” may be acquired as the communication quality.

In step S608, it is determined whether the communication quality of the communication that has become able to communicate is higher than the communication quality of the current communication. If the determination is Yes, the process proceeds to step S610. Otherwise, the process proceeds to step S612.

In step S610, it is determined that a switching is necessary.

In step S612, it is determined that a switching is unnecessary.

FIG. 7 is a flowchart illustrating an exemplary process according to the present exemplary embodiment (transmission method/channel switching module 130).

In step S702, it is inquired whether it is possible to switch between transmission methods or between channels, to the communication device 180 which is the communication counterpart device.

In step S704, it is determined whether a reply from the communication device 180 indicates that it is possible to switch between transmission methods or between channels. If it is determined that the reply indicates it is possible to switch between the transmission methods or between the channels, the process proceeds to step S706. Otherwise, the process proceeds to step S712.

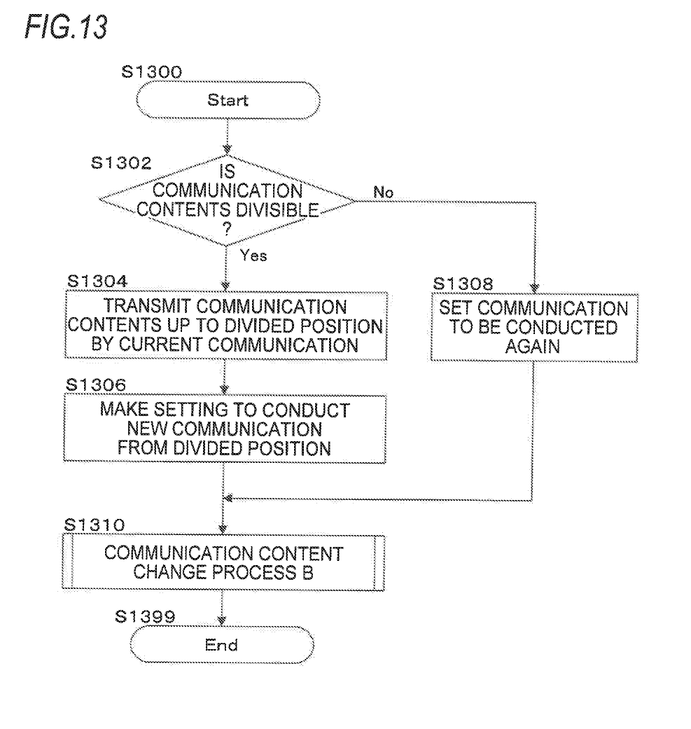

In step S706, a communication content change process A is performed. The detailed process of step S706 will be described later using the flowchart illustrated in an example of FIG. 13.

In step S708, the current communication is disconnected.

In step S710, a communication is started by the new transmission method or channel. For example, a communication maybe started from the beginning by the new transmission method or channel, or the remaining communication may be conducted by the new transmission method or channel.

In step S712, the wireless communication module 135 continues the current communication.

FIG. 8 is a flowchart illustrating an exemplary process according to the present exemplary embodiment (switching determination module 120).

In step S802, a priority of the current communication is acquired and the acquired value is substituted into a value of the variable N.

In step S804, it is determined whether N=1 (the variable N is 1). If it is determined that N=1, the process proceeds to step S814. Otherwise, the process proceeds to step S806.

In step S806, X=1 (1 is substituted into the variable X).

In step S808, it is determined whether the transmission method of the priority:X is free (is able to communicate). If it is determined that the transmission method is free, the process proceeds to step S816. Otherwise, the process proceeds to step S810. Here, the “transmission method of the priority:X” is extracted using the priority table 900 or 1000.

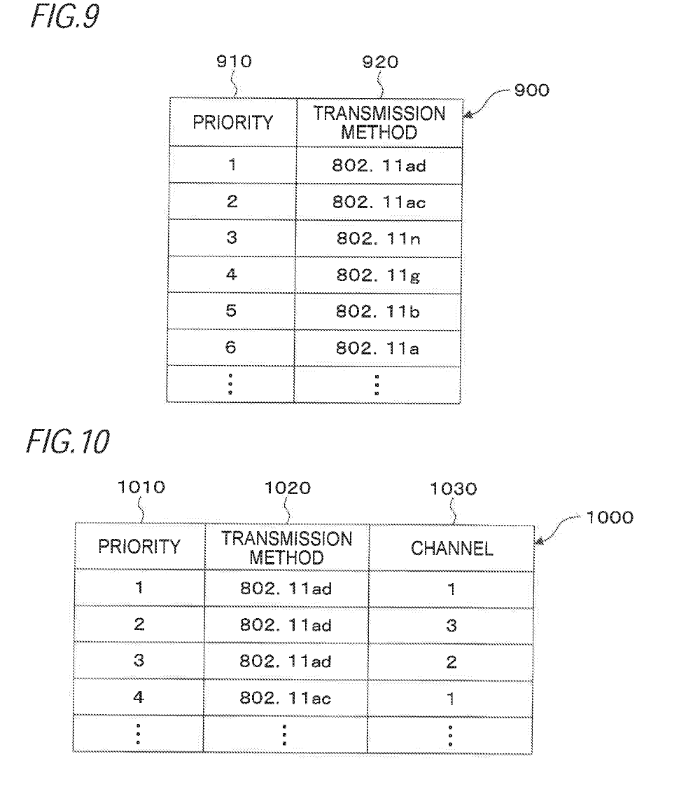

FIG. 9 is an explanatory view illustrating an exemplary data structure of the priority table 900. The priority table 900 has a priority column 910 and a transmission method column 920. The priority column 910 stores priorities. The transmission method column 920 stores transmission methods corresponding to the priorities. In this example, priorities are assigned in an order of transmission speeds from the highest speed.

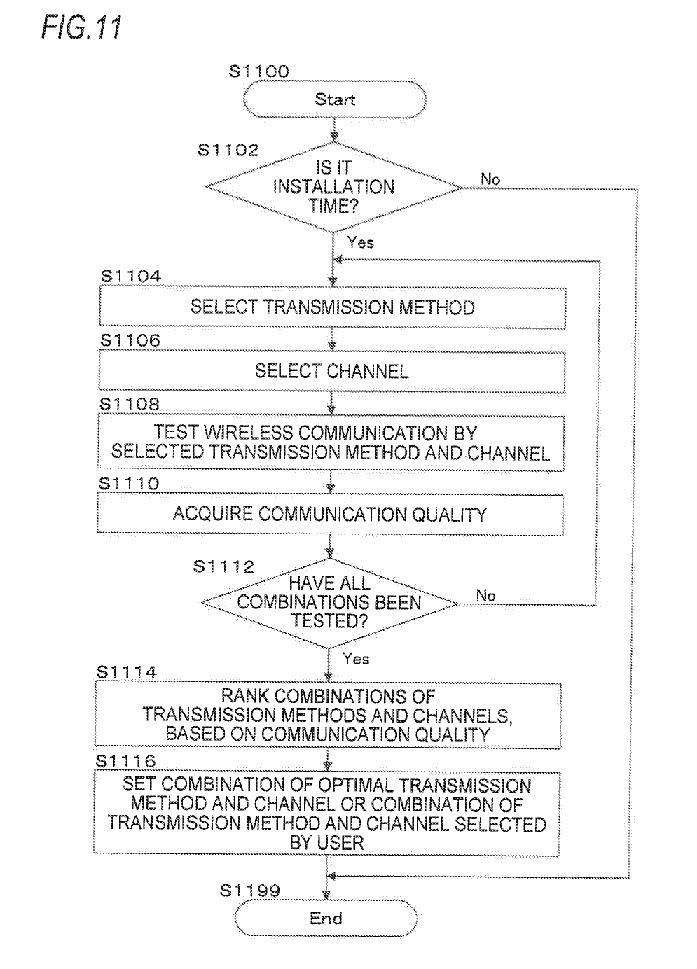

FIG. 10 is an explanatory view illustrating an exemplary data structure of the priority table 1000. The priority table 1000 has a priority column 1010, a transmission method column 1020, and a channel column 1030. The priority column 1010 stores priorities. The transmission method column 1020 stores transmission methods corresponding to the priorities. The channel column 1030 stores channels corresponding to the priorities. The priority table 1000 allows to select, for example, a combination of a transmission method and a channel which have a fast communication speed and cause the small number of communication errors. The number of communication errors may be calculated from past communication histories. In addition, the priority table 1000 may include the combinations of the transmission methods and the channels that are ranked by a process of a flowchart illustrated in an example of FIG. 11.

In step S810, X=X+1 (the variable X is incremented).

In step S812, it is determined whether X=N (values of the variables X and N are equal to each other). If it is determined that X=N (if all transmission methods having higher priorities than that of the current communication are investigated), the process proceeds to step S814. Otherwise, the process returns to step S808.

In step S814, it is determined that a switching is unnecessary.

In step S816, a switching is necessary, and the priority:X is returned. With this configuration, in step S710 of the flowchart illustrated in the example of FIG. 7, a new communication is started by the transmission method and the channel of the priority X.

FIG. 11 is a flowchart illustrating an exemplary process according to the present exemplary embodiment (the information processing apparatus 100). When the information processing apparatus 100 is installed, the information processing apparatus 100 may automatically send a radio signal and receive a reception signal from a counterpart device by a diagnosis function (auto-diagnosis function) of the information processing apparatus 100, and may construct a combination of optimal transmission method and channel (may generate the priority table 1000) according to the obtained detection data.

In step S1102, it is determined whether it is the installation time of the information processing apparatus 100 (the initial setting time). If it is determined that it is the installation time, the process proceeds to step S1104. Otherwise, the process is ended (step S1199). This is because main communication environments (place and area) are determined at the installation time of the information processing apparatus 100.

In step S1104, a transmission method is selected. An order in which a target transmission method is selected from among multiple transmission methods may be determined in advance.

In step S1106, a channel is selected. An order in which a target channel is selected from among multiple channels may be determined in advance.

In step S1108, a test wireless communication is conducted by the transmission method and the channel which are selected in steps S1104 and S1106.

In step S1110, the communication quality is acquired.

In step S1112, it is determined whether all combinations have been tested. If it is determined that all the combinations have been tested, the process proceeds to step S1114. Otherwise, the process returns to step S1104.

In step S1114, the combinations of the transmission methods and the channels are ranked based on the communication quality. That is, a combination having a better communication quality ranks high. The result of the ranking is generated as the priority table 1000.

In step S1116, a combination of an optimal transmission method and channel or a combination of a transmission method and a channel that are selected by a user is set. If there are multiple combinations of transmission methods and channels that have a higher communication quality than a predetermined value, a user may select one from the multiple combinations.

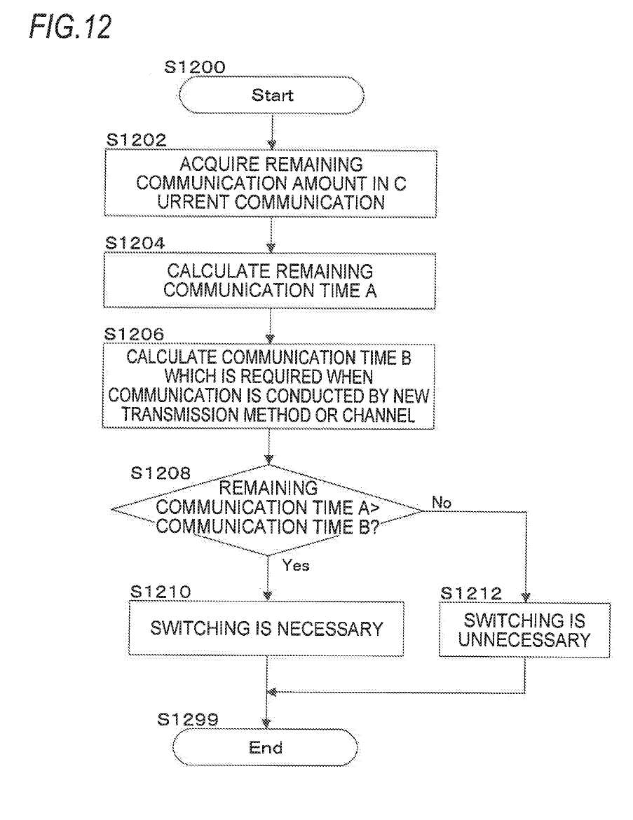

FIG. 12 is a flowchart illustrating an exemplary process according to the present exemplary embodiment (switching determination module 120).

Instead of performing step S610 of the flowchart illustrated in the example of FIG. 6, the process of the flowchart illustrated in the example of FIG. 12 may be performed.

Also, instead of performing step S816 of the flowchart illustrated in the example of FIG. 8, the process of the flowchart illustrated in the example of FIG. 12 may be performed. It should be noted that in step S1210, “a switching is necessary and the priority:X is returned”.

In step S1202, a remaining communication amount of the current communication is acquired.

In step S1204, a remaining communication time A is calculated using the remaining communication amount and the communication speed (a nominal value or a performance value) of the transmission method or channel.

In step S1206, a communication time B which is required when a communication is conducted by the new transmission method or channel is calculated. For example, if the communication is conducted again from the beginning by the new transmission method or channel, the communication time B is calculated using the communication capacity and the communication speed (a nominal value or a performance value) of the new transmission method or channel. If the remaining communication is conducted by the new transmission method or channel, the communication time B is calculated using the remaining communication amount and the communication speed (a nominal value or a performance value) of the new transmission method or channel.

In step S1208, it is determined whether “remaining communication time A>communication time B.” If it is determined that “remaining communication time A>communication time B” (if the communication is completed relatively fast when the communication is switched to the new transmission method or channel), the process proceeds to step S1210. Otherwise, the process proceeds to step S1212.

In step S1210, it is determined that a switching is necessary.

In step S1212, it is determined that a switching is unnecessary.

FIG. 13 is a flowchart illustrating an exemplary process according to the present exemplary embodiment (communication content change process A).

In step S1302, it is determined whether communication contents are divisible. If it is determined that the communication contents are divisible, the process proceeds to step S1304. Otherwise, the process proceeds to step S1308. As described above, the case where the communication contents are divisible corresponds to, for example, a case where communication contents are multiple sheets of images, a document having multiple pages, or the like.

In step S1304, the communication contents are transmitted by the current communication up to the divided position.

In step S1306, a setting is made to conduct a new communication from the divided position.

In step S1308, a setting is made to conduct a communication again (perform a retransmission), and the process proceeds to step S1310.

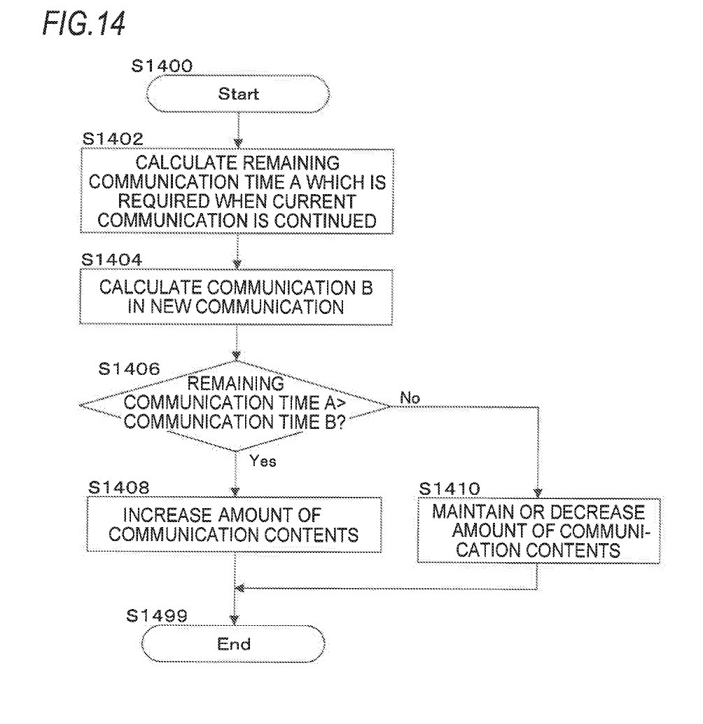

In step S1310, a communication content change process B is performed. The detailed process of step S1310 will be described later using the flowchart illustrated in the example of FIG. 14.

FIG. 14 is a flowchart illustrating an exemplary process according to the present exemplary embodiment (communication content change process B).

In step S1402, a remaining communication time A which is required when the current communication is continued is calculated. Specifically, the remaining communication time A may be calculated using the remaining amount and the communication speed (a nominal value or a performance value).

In step S1404, a communication time B which is required in the new communication is calculated. Specifically, the communication time B may be calculated using (i) the remaining amount (or the amount of the entire communication contents in the case of retransmission) and (ii) the communication speed (a nominal value or a performance value (a performance value in the transmission method or channel that has been used until then in the new communication).

In step S1406, it is determined whether “remaining communication time A>communication time B.” If it is determined that “remaining communication time A>communication time B” (if a communication is completed relatively fast when a switching is performed), the process proceeds to step S1408. Otherwise, the process proceeds to step S1410.

In step S1408, the amount of the communication contents is increased. For example, as described above, the resolution of an image is increased.

In step S1410, the amount of the communication contents is maintained or decreased. This process is performed in a case where a communication is completed late if a switching is performed. This case corresponds to, for example, a case where the communication before the switching may not be conducted. In step S1402, the remaining communication time A with the assumption that the communication is normally continued is calculated. Specific examples of decreasing the amount include reducing the resolution of an image and increasing a compression ratio in a compression method.

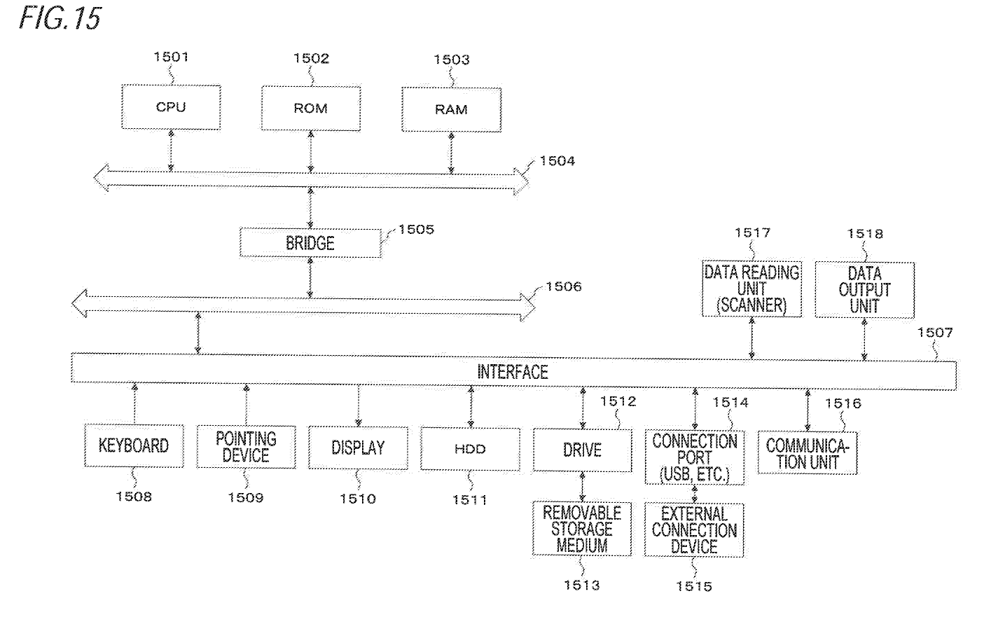

An exemplary hardware configuration of the information processing apparatus of the present exemplary embodiment will be described with reference to FIG. 15. The configuration illustrated in FIG. 15 is implemented with, for example, a personal computer (PC), and represents an exemplary hardware configuration provided with a data reading unit 1517 such as a scanner and a data output unit 1518 such as a printer. In addition, while the example illustrated in FIG. 3 represents the configuration mainly serving as a chip using the ASIC or the like, the example illustrated in FIG. 15 mainly represents a functional configuration that is implemented with a personal computer or the like. For example, a CPU 1501 takes in charge of the functions of the SoC 300 and the ASIC 330.

The CPU 1501 is a controller that performs processes according to a computer program describing an execution sequence of each of the various modules described in the above-described exemplary embodiment, that is, the communication control module 110, the communication quality acquisition module 115, the switching determination module 120, the communication content change module 125, the transmission method/channel switching module 130, the wireless communication module 135 and the like.

A read only memory (ROM) 1502 stores programs, operation parameters and the like used by the CPU 1501. A RAM 1503 stores programs used in the execution by the CPU 1501, parameters appropriately varying in the execution and the like. These components are connected to each other by a host bus 1504 configured with a CPU bus or the like.

The host bus 1504 is connected to an external bus 1506 such as a peripheral component interconnect/interface (PCI) bus via a bridge 1505.

A keyboard 1508 and a pointing device 1509 such as a mouse are devices operated by an operator. A display 1510 is, for example, a liquid crystal display device or a cathode ray tube (CRT), and displays various types of information as texts and image information. In addition, a touch screen or the like having the functions of both the pointing device 1509 and the display 1510 may be used. In this case, the function of the keyboard may be implemented by drawing the keyboard using software (also called a so-called software keyboard, screen keyboard or the like) on the screen (the touch screen), without the physical connection as in the keyboard 1508.

A hard disk drive (HDD) 1511 is equipped with a hard disk (which may be a flash memory or the like) therein, drives the hard disk, and stores or plays programs or information executed by the CPU 1501. The hard disk stores the priority tables 900 and 1000, communication contents and the like. Further, in the hard disk, other various data and various computer programs are stored.

A drive 1512 reads data or programs stored in a removable storage medium 1513 such as a mounted magnetic disc, an optical disc, a magneto-optical disc, or a semiconductor memory, and supplies the data or programs to the interface 1507, the external bus 1506, the bridge 1505, and the RAM 1503 connected via the host bus 1504. In addition, the removable storage medium 1513 may also be used as a data storing area.

A connection port 1514 is a port for connection of an external connection device 1515, and includes connection units such as USB and IEEE1394. The connection port 1514 is connected to the CPU 1501 and the like via the interface 1507, the external bus 1506, the bridge 1505, the host bus 1504 and the like. A communication unit 1516 is connected to a communication line and performs a process of a data communication with an external device. The data reading unit 1517 is, for example, a scanner and performs a document reading process. The data output unit 1518 is, for example, a printer and performs a document data outputting process.

The hardware configuration of the information processing apparatus illustrated in FIG. 15 represents an exemplary configuration. The present exemplary embodiment is not limited to the configuration illustrated in FIG. 15, and maybe any configuration that may execute the modules described in the present exemplary embodiment. For example, some of the modules may be configured with dedicated hardware (e.g., application specific integrated circuit (ASIC)), and some of the modules maybe in the form in which the modules are present in an external system and connected via a communication line. Further, the multiple systems illustrated in FIG. 15 may be connected to each other via a communication line and cooperate with each other. In addition, especially, the multiple systems of FIG. 12 may be incorporated in a personal computer, a portable information communication device (including a mobile phone, a smart phone, a mobile device, a wearable computer, and the like), an information appliance, a robot, a copying machine, a facsimile, a scanner, a printer, a multifunctional machine (an image processing apparatus having two or more functions of a scanner, a printer, a copying machine, a facsimile and, the like), and the like.

In the comparing process described in the above-described exemplary embodiment, the expressions “equal to or more than,” “equal to or less than,” “larger than,” and “smaller than (not exceeding)” may be replaced with “larger than,” “smaller than (not exceeding),” “equal to or more than,” and “equal to or less than,” respectively unless the replacement causes contradiction.

In addition, if the communication quality is not improved even by changing a transmission method, the channel may be switched to another channel. Here, specifically, the case where the “communication quality is not improved” corresponds to (i) a case where a difference between values of the communication quality before and after the transmission method switching is within a predetermined value or (ii) a case where the communication quality after switching between the transmission methods is worse than that before switching between the transmission methods.

The above-described programs may be provided in the form of being stored in a storage medium or provided by a communication unit. In this case, for example, the above-described programs may be construed as an invention of a “computer readable storage medium storing a program.”

The “computer readable storage medium storing a program” refers to a computer readable storage medium storing a program, which is used for installation, execution, distribution, and the like of a program.

The storage medium includes, for example, a digital versatile disc (DVD) such as “DVD-R, DVD-RW, DVD-RAM or the like” which is the standard formulated in the DVD forum, “DVD+R, DVD+RW or the like” which is the standard formulated in DVD+RW, a compact disc (CD) such as a CD read only memory (CD-ROM), a CD recordable (CD-R), or a CD rewritable (CD-RW), a Blu-ray disc (Blu-ray (registered trademark) disc), a magneto-optical (MO) disc, a flexible disk (FD), a magnetic tape, a hard disk, a ROM, an electrically erasable and rewritable read only memory (EEPROM (registered trademark)), a flash memory, a random access memory (RAM), and a secure digital (SD) memory card.

All or some of the above-described programs may be stored in the storage medium so as to be saved or distributed. Further, the programs may be transmitted using a transmission medium such as a wired network used in a local area network (LAN), a metropolitan area network (MAN), a wide area network (WAN), the Internet, the Intranet, the Extranet, and the like, a wireless communication network, or a combination thereof, or may be carried on carrier waves.

In addition, the above-described programs maybe all or parts of other programs, or may be stored together with separate programs in the storage medium. In addition, the above-described programs maybe divided and stored in multiple storage media. In addition, the above-described programs may be stored in a compressed or encrypted form as long as the programs may be restored.

The above-described exemplary embodiment may be construed as described below.
[A1] An information processing apparatus including:
   a communication unit configured to conduct a wireless communication using plural transmission methods, at least one of which has plural channels; and
   a switching unit, in which when a channel or transmission method having a higher communication quality than that of a communication that is being conducted has become able to communicate, the switching unit switches to the channel or the transmission method having the higher communication quality.
[A2] The information processing apparatus according to [A1], in which the switching unit is configured to perform the switching according to a remaining communication amount.
[A3] The information processing apparatus according to [A1], in which the switching unit is configured to switch a transmission method to IEEE802.11ad.
[A4] A non-transitory computer readable medium storing an information processing program that, when executed, causes a computer to function as:
   a communication unit configured to conduct a wireless communication using plural transmission methods, at least one of which has plural channels; and
   a switching unit, wherein when a channel or transmission method having a higher communication quality than that of a communication that is being conducted has become able to communicate, the switching unit switches to the channel or the transmission method having the higher communication quality.

The above-described modified exemplary embodiments may have the following effects.

With the information processing apparatus of [A1], switching between channels or switching between transmission methods may be performed according to a communication quality of a communication that is being conducted.

With the information processing apparatus of [A2], a switching may be performed according to a remaining communication amount.

With the information processing apparatus of [A3], a transmission method may be switched to IEEE802.11ad.

With the non-transitory computer readable medium of [A4], switching between channels or switching between transmission methods may be performed according to a communication quality of a communication that is being conducted.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing apparatus comprising:
a communication unit configured to conduct a wireless communication using a plurality of transmission methods each having a plurality of channels; and
a change unit, wherein when a channel or a transmission method is switched during a communication, the change unit changes contents to be communicated after the switching, according to the channel after the switching or the transmission method after the switching.

2. The information processing apparatus according to claim 1, wherein the contents to be communicated after the switching is changed further according to the contents to be communicated.

3. The information processing apparatus according to claim 2, wherein if the contents to be communicated are not divisible, the contents are communicated from the beginning after the switching.

4. The information processing apparatus according to claim 1, wherein if the channel after the switching or the transmission method after the switching has a higher communication quality than that of the channel before the switching or the transmission method before the switching, an amount of the contents to be communicated after the switching is changed to be larger than that of the contents before the switching.

5. The information processing apparatus according to claim 4, wherein if the contents are an image, a resolution of the image to be communicated after the switching is changed to be higher than that of the image before the switching.

6. A non-transitory computer readable medium storing an information processing program that, when executed, causes a computer to function as:
a communication unit configured to conduct a wireless communication using a plurality of transmission methods each having a plurality of channels; and
a change unit, wherein when a channel or a transmission method is switched during a communication, the change unit changes contents to be communicated after the switching, according to the channel after the switching or the transmission method after the switching.

7. An information processing apparatus comprising:
communication means for conducting a wireless communication using a plurality of transmission methods each having a plurality of channels; and
change means, when a channel or a transmission method is switched during a communication, for changing contents to be communicated after the switching, according to the channel after the switching or the transmission method after the switching.
